(19) United States
(12) Patent Application Publication
(10) Pub. No.: US 2010/0074423 A1
(43) Pub. Date: Mar. 25, 2010

(54) Communicating Device with Data Lookup and Anti-Call Function

(76) Inventor: Scott C. Harris, Rancho Santa Fe, CA (US)

Correspondence Address: SCOTT C HARRIS;Law Office of Scott C Harris, Inc, P O BOX 1389, Rancho Santa Fe, CA, 92067-1389, US

(21) Appl. No.: 12/233,586

(22) Filed: Sep. 19, 2008

(51) Int. Cl. H04M 1/66; H04M 15/00

(52) U.S. Cl. 379/111; 379/199

(57) ABSTRACT

A phone anti-stalk system operates by determining when a user has carried out actions that are unacceptable. This can operate according to a rule, for example, which prevents the user from being allowed to receive calls after the user carries out some kind of action like making too many calls in a row. Rules are set which block communications from those users who carry out specified actions, like calling repeatedly without leaving messages. The user is then automatically blocked for some amount of time. The user anti-stalk criteria is stored associated with the contact's information, so that any time a communication comes in from that contact, it is automatically prevented from being indicated. The contacts of the user can also be set so that they automatically update based on information from a remote database.

### BACKGROUND

Telephones and personal digital assistants or PDAs have converged to form devices that can be used to make calls, obtain information, and store personal information and personal preferences. A person's contact list is as stored in their phone or PDA, is often their primary contact list.

Services such as “windows Live” allow contact lists to be stored on line.

### SUMMARY

The present application describes communicator with features that can enhance a database accessed by a personal unit.

An embodiment describes additional features that can be associated with contacts on a computer of a type that stores information, such as the cellular phone, PDA or the like.

Another embodiment describes how a database of information that is accessed by a contact interface structure such as a PDA processor can be enhanced by looking up unknown parts for example on the Internet.

### BRIEF DESCRIPTION OF THE DRAWINGS

These and other aspects will be described in detail with reference to the accompanying drawings, wherein:

FIG. 1 shows a personal communicator and certain menus usable in that communicator;

FIG. 2 shows options that can be obtained upon received calls;

FIG. 3 shows a flowchart of operation carried out by a processor in the handheld unit.

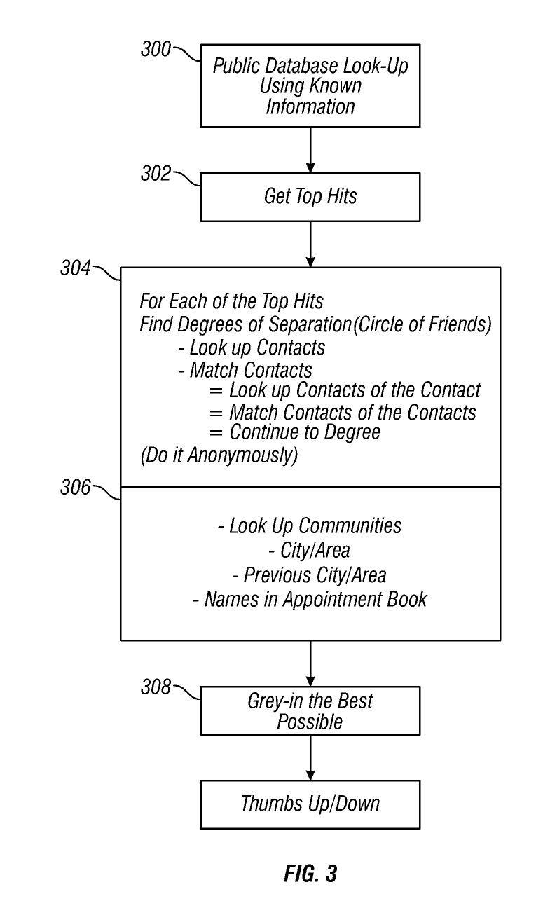

FIG. 4 shows an exemplary contact form showing all the different fields that can be included.

### DETAILED DESCRIPTION

The intent of a communicator is to allow receiving a communication. But sometimes people go too far. Some people will call continually, so-called stalking behavior. Sometimes salesmen do this. In general, the inventor found that when people call repeatedly in certain ways, there is typically a reason why. You might not want to talk to those people. These actions by themselves can be used as indications of the fact that you may not want to talk to such a person.

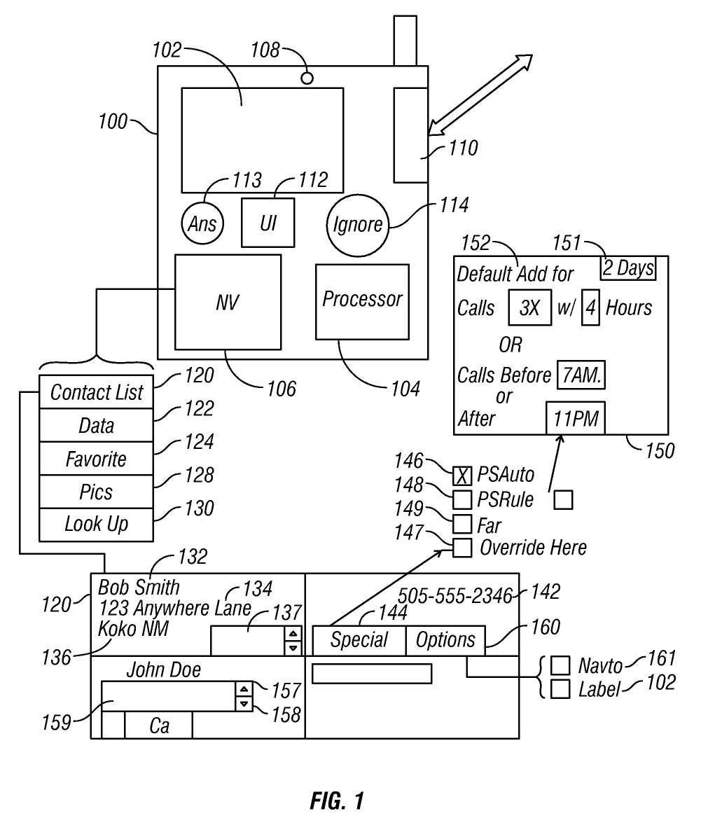

FIG. 1 shows a handheld unit 100, which can include communication capability. Preferably, in one embodiment, this can be a handheld cellular phone or PDA that allows making calls or sending e-mails or text. The PDA may include a display 102, a processor 104 which controls operation of different functions, and a nonvolatile memory 106. The PDA may also include a camera 108, and a cellular transceiver 110 which can send and receive information both over the cellular network and over the Internet.

The nonvolatile memory 106 can store information entered by the user. The information may include, but is not limited to, a contact list, 120, a user's personal data 122, a user's favorites of various types 124, pictures from camera 128, and a lookup table 130 that may be a form allowing a user to look up various information. FIG. 1 also illustrates further detail about the contact list 120. This list may include a number of contact names arranged in any specified order, such as by last name, first name, or by frequency of lookup or of calling. The contact list may include a person, here Bob Smith 132, their address 134, and their city and state. Often, however, that the user does not know the entire details of a person in the contact list. For example, in the contact 132, the ZIP code portion 137 is blank. This is shown in dotted lines, because it is a “fill-in feature”, that will be obtain candidates for automatic fill in by look up the database as described herein. A phone number field 140 is also associated with the contact 132. This may include the person's phone number 142, mobile, home, and others.

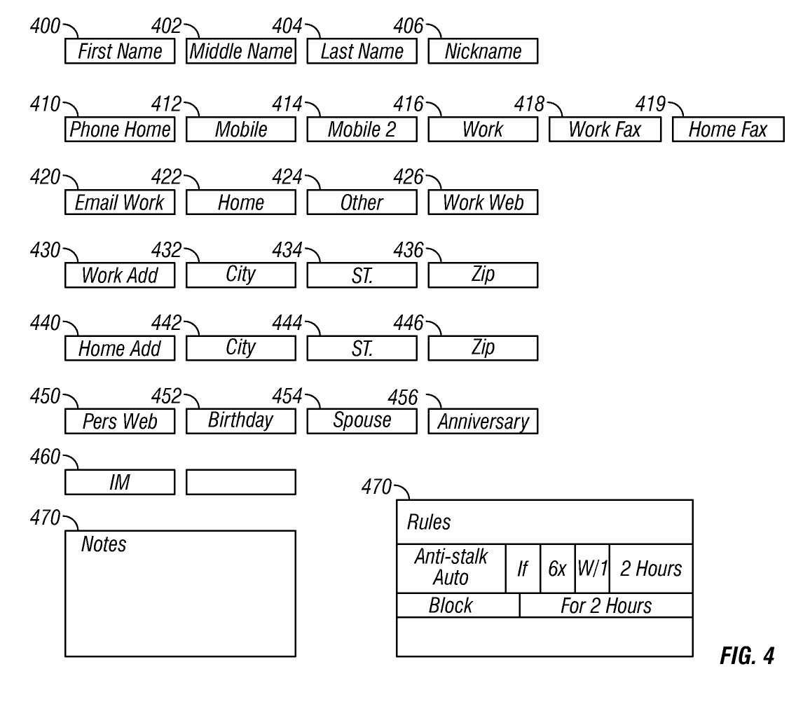

FIG. 4 illustrates the different fields that might be included in a contract, including a first name 400, middle name 402, last name 404 nickname 406. Home phone 410 mobile phone 412 and second mobile phone 414. E-mail addresses work 420, home 422 and other 424. Work address 430, city 432, state 434, zip 436 are also included. The work number is at 416, but could also be at 436 in the alternative. Similarly, the work fax number is shown as 418, but could also be in the work area. A home fax is shown as 419. Home addresses are shown as 440, 442 for the city 444 for the state and 446 for the zip.

Below that is personal information personal website 450, birthday 452, spouse or significant other 454, anniversary 456 and/or work website 426. 460 can be an IM address. There can also be other miscellaneous fields. A notes field at 470 can be a freeform field allowing a user to put any kind of notes into the system. In addition, although not shown in FIG. 4, there can be digital IDs and the like added to the contact list. FIG. 4 also shows a generic rules list, including anti-stalk auto rules of the type discussed above. In addition, it may include a special control 144, and an options control 146.

A special control 144 allows special functions to be carried out based on this user. A first of these functions is an anti-phone stalk function. Often, people receive unwanted telephone calls from certain people. These calls may be from ex-husband or ex-boyfriend, but may also be from other people. For example, this may include salesmen, or just general undesired callers.

A number of different phone stalk options are available according to the present system. The special button 144 brings up many of these different phone stalk options.

The phone stalk auto options 146 uses defaults to add a user to a phone stalk list.

The phone 108 also includes additional controls including a user interface 112 which may be a keyboard or a partial keyboard, an answer button for incoming phone calls, and an ignore button for ignoring phone calls. Many phones include the ability to ignore a call, which typically causes the call to go directly to voice mail and to stop ringing. One advantage of this system is that it allows the electronic circuit itself to block the communication, rather than requiring the server to take part in blocking that communication. For example, some systems of this type may require blocking on the server. This requires the server to have interaction with the software, and typically the owner of the server will try to charge for that interaction. This system can run on the client itself, for example on the cell phone or PDA, and automatically cause the communication to be blocked.

While the above describes blocking communication of a cell phone call, it should be understood that this can also block other kinds of communication such as text messages, IMs, emails and others. The system can prevent an “indication” of the communication, e.g., a ring, or for a written type message such as an email, text or IM, can prevent the message from appearing on the user's message list.

The phone stalk rule button 148 include pulldown options, allowing the user to set any of a number of different rules as alternates to the default rule. Each of the rules may be named, and each of the rules may have different characteristics.

Either the phone stalk auto or the phone stalk rule may bring up the interface shown in 150 which is shown as the default. A number of different features can be pulled from the pulldown menu. The first is the add for feature, which may add to the anti-stalk list for a number of time, which could be two hours/today/2 weeks/forever. Other times could also be filled in, but preferably the amounts of time increase geometrically in some fashion, rather than additively, two days. The inventor recognizes that it may be difficult for a user to decide a precise amount of time to carry out the blocking. Accordingly, the user is relieved from making the difficult decision like should it be one day or two days. Rather, the user is only prevent presented with options for hours, days, weeks, months, thereby simplifying the decision down to one of order of magnitude rather than exact amount.

152 represents a field which indicates actions that a caller needs to take into order to be added to the automatic phone stalk option. According to 152, for example, if the user calls three times within four hours, or calls before 7 AM or after 11 PM, or calls twice within an hour without leaving a message, or does any other action or combination of actions on the phone stalk action list. When a caller does the combination or single thing, the caller's caller ID is automatically added to the phone stalk list.

Thereafter, when a calling number comes in matching a phone stalk blacklisted customer, the phone is prevented from accepting the call. In one embodiment, this can be done by actuating the ignore button 114 automatically by software running in the phone 100. This causes the phone to ignore the call, sending it directly to voice mail, and preventing the phone from ringing.

Other “special” items can include a favorite button 149 which adds the user to favorites, thereby bringing that user to the top of the list, and giving them have preferred characteristics. For example, adding a user as a preferred user might make the user immune from the phone stalk rules. It may allow the preferred users to have some other preferences on calls, also. For example, user's best friends might be stored as favorites, making them immune from many of the rules. On the opposite end, a user may warn their ex-husband “don't call 3 times in a row without leaving a message, or you'll get automatically blocked after that.

Another option is to set the antistalk to zero—in which case the callers (other than favorites) are simply blocked before 7; after 11, or after 3 unanswered calls (in the example above). This prevents people from calling outside the designated hours unless they are set as “favorites”.

Another option is the override share button 147, which overrides the sharing of the user's contact information with the database.

Options button 160 allows certain actions to be taken with these contacts. One option 161 is a navigate-to option. This causes the address associated with the contact to be automatically loaded. Navigation to that address can be loaded to start either immediately or as a “stored destination” or “previous destination” to be used later. The navigation can being by using a GPS or other navigation system to navigate to that address.

Another option may send to the selected address as an e-mail or other message over the Internet or cell phone channel to an Internet connected browser that alternatively carries out this operation.

Yet another option is the label control, 162, which automatically creates a label, and sends it wirelessly to a wirelessly controlled printer. Other options may include the ability, for example, to create a letter to the person creating e-mail to the person, or other such.

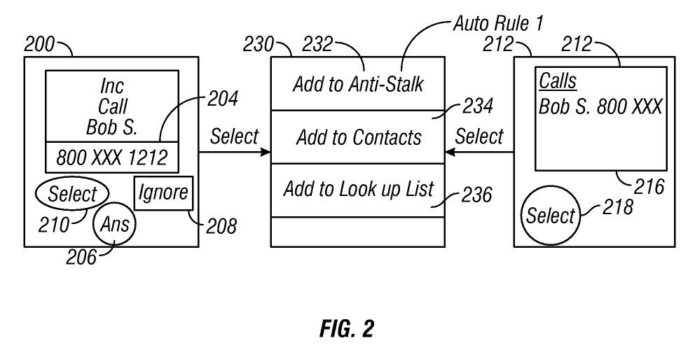

The previously described menus may be one way of controlling the options. FIG. 2 illustrates how the options can be controlled based on incoming calls, or based on missed calls. FIG. 2 illustrates two screens that are shown on the unit.

200 illustrates a screen that is displayed when an incoming call is received, showing that Bob S. is calling, showing Bob S's number 204, and providing a number of different options to answer 206, to ignore 208, or to select 210. Selecting automatically brings up the screen 230 with a number of options for the selected item. Similarly, 212 shows the screen 214 for missed calls. This shows Bob S's missed call as 216 which again can be selected using the select button 218. Selecting brings up the menu 230. The menu indicates different things that can be done with these calls. One of the selections at 232 include adding the number to an anti-stalk list. This allows manual entry of a number to the anti stalk list, unlike the previous embodiments which automatically add the number to a list when the caller carries out certain actions. This can be a manual add option without requiring the user to carry out actions in order to be added.

The number is added to the anti-stalk list for some amount of time. This amount of time can be that specified in the auto parameter of how long the number is added, or can be selected based on a custom amount of time.

The present application may be executed on a special purpose processor/computer that is used for maintaining contacts, initiating calls and other communications, and carrying out actions relative to those communications and contacts.

For example, custom rules can include as described above only adding the user to the phone anti stalk when the person calls to often or at strange times. It also provides the ability to add to contacts at 234, or add to the lookup list at 236. Adding a contact to the lookup list at 236 adds the contact to the stored data 122.

The computer subsequently looks up to obtain additional information about the contact. This lookup may look for information about the contact. The looked up information can be added.

The data lookup can be immediate in one embodiment. In another embodiment, the data lookup can be asynchronous, e.g., during off hours. Another embodiment may look up the information, or off line, e.g., only during other data acquisitions. In one embodiment, the contents of the contact list are all shared with a server at intervals, e.g., each night at midnight. Each sharing causes lookup of the data fields that are empty. This lookup uses data on the server. The lookup updates empty fields on the stored fields. This also updates contact names and information on the server, to allow the degrees of separation lookup as described herein.

According to an embodiment, when items are added to the contact list, they may have some information or no information. For example, when you add Bob S. to the contact list 234, it may include Bob S's caller IDed number and the name that comes up (e.g., Bob S). This will be added to the contact list, but this will include no other information about Bob S. This embodiment uses a lookup system to look up information about Bob S. This information is used to fill in automatically blanks in the contact information.

The operation uses the processor 104, as well as an Internet connection, to look up in the public database at 300 using known information. Very often, this known information may include only information from the caller ID, e.g., a name or part of a name, and a phone number. In this case, the lookup can do a reverse phonebook lookup of the number based on public databases, e.g., a search engine such as Google, public databases of phone numbers, and the like.

This system allows a user to enter the parts of the information that they have, and have the system use information, including information from other contacts of other people, to try to fill in the rest.

The contacts can be “uploaded” to the server, and used for two reasons—to allow the user to get their own contacts from the server, and also to allow other users to get additional information to fill in to their own contacts, from contacts of others. However, no user can get other user's contacts, only information to fill in from those other users' contacts. Users can also designate any of their contacts as being “personal” to prevent sharing.

Based on the available information in the contact and the lookup, 302 gets the top results from the lookup. It is possible that this may be ambiguous information, especially when the information entered might only be name and e-mail address or even just name.

For example, a user might enter the name “Susie” and nothing else.

This can be searched against the internet, telephone lookups.

Some of the fields may be easy to figure out how to fill in. For example, if you have an address, a zip code database can be used to automatically fill in the ZIP code. If you have a phone number, reverse phone lookup may be used to find certain information. However, other personal data of the user may be more difficult to ascertain.

Another embodiment searches against other contact lists that are stored on the main server. These are contact lists stored by other people. The contact lists are searched to find information for fill in to the current user's contacts. Preferably, these are stored in a way that prevent anyone else from finding the contacts themselves—they are only usable to get information for fill in for the current user's contacts.

Each of the top hits obtained at 302 is analyzed to determine its “degrees of separation” relative to the user. In order to use the degrees of separation, the user's contact list may be shareable. In an embodiment, when the user looks up information for their contact list, the user also shares their own information. In this embodiment, the user's name is associated with contacts Bob Smith and John Joe and all the other contacts from FIG. 1. The user's contacts are shared in a way that does not allow others to obtain access to a user's personal contacts. The system only allows the determination of degrees of separation.

So for each of the top hits, the system determines the degrees of separation by looking up the contacts that are associated with the present users. The contacts of each of the contacts associated with the present user are analyzed.

For example, say you are Scott, and you have the contacts Sam and Bob and Jim. Sam has contacts Jim and John. Sam's contacts are called “second degree contacts” relative to Scott. If there is a lookup for Jim from Scott's contacts, then Jim from Sam's contacts is very likely to be the same Jim. Information from Sam's Jim can be copied to Sam's Jim.

For a third degree of separation, you can look up the contacts of the contacts. Then, you can match the contacts of the contacts with both the contacts and with you. For example, you can look up bob's contacts, Joe and Jana. Joe and Jana are called “third degree contacts” relative to Scott.

You can continue this to degree n, understanding that statistically after degrees 4 or 5, there will be many different coincidences of contacts. Contact coincidences in degrees 2 and 3 are rare, but in three or four are frequent.

So, by entering the name Susie, you could find everybody name Susie in the database, and find their contacts. Maybe you are in their contacts, or maybe you have, and contacts. A rating according to the similarities between Susies you find, and the owner of the contacts list, e.g., the degree of separation of the contacts can be made at 304.

At 306, other commonalities are determined. This may include, for example, looking up the city and area of the contact and the list owner, to determine if the list owner is in the same area as the contacts. It can include previous areas in which the list owner previously lived, or frequently visited areas or areas where the user has a lot of other contacts. It can also include names in an appointment book, for example. Based on all of this information, the best possible option is analyzed to 308 and returned to fill in blanks in the contact form.

These options are returned in a different color or font into the menu of FIG. 1. For example, the item 137 may be filled in FIG. 1, or the address 159 associated with John Joe. These items that are displayed in a different way until verified. A user can review the item and determine if they think that it is correct or not. According to this embodiment, the item such as 159 is associated with a thumbs-up icon 157 and a thumbs down icons 158. If the filled in information is incorrect, the user may select the thumbs down icons, which may cause a new search and caused new information to be postulated. If the information is correct, the thumbs-up icon 157 may be executed. This causes the information to become permanent, and to remove the icons and the determinations.

The general structure and techniques, and more specific embodiments which can be used to effect different ways of carrying out the more general goals are described herein.

Although only a few embodiments have been disclosed in detail above, other embodiments are possible and the inventor intends these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example, other numbers of batteries can be used, and other charging devices, as well as other connection devices besides relays. Solid state switches may be used.

Also, the inventor intends that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The computer may be an Intel (e.g., Pentium or Core 2 duo) or AMD based computer, running Windows XP or Linux, or may be a Macintosh computer. The computer may also be a handheld computer, such as a PDA, cellphone, or laptop.

The programs may be written in C or Python, or Java, Brew or any other programming language. The programs may be resident on a storage medium, e.g., magnetic or optical, e.g. the computer hard drive, a removable disk or media such as a memory stick or SD media, wired or wireless network based or Bluetooth based Network Attached Storage (NAS), or other removable medium or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

What is claimed is:

1. A system comprising:
a memory, storing at least one identification indicative of a communication;
a processing element controlling communication, and in communication with said memory to read said identification, which has a condition that causes said processing element to prevent a communication with said identification from causing an indication; and
said processor operating according to a rule which sets said condition for said at least one identification, said condition causing said processor to modify further communication from said identification to automatically prevent said indication.

2. A system as in claim 1, wherein said identification is a telephone number, said indication is a ring associated with an incoming telephone call, and wherein said rule causes further communications from said telephone number to automatically be prevented from causing said ring.

3. A system as in claim 1, wherein said identification is an identification of a source of a written message, said indication is associated with signaling an incoming written message, and wherein said indication is a display of said message, and wherein said rule prevents further communications from said source email from being displayed.

4. A system as in claim 1, wherein said processor operates according to said rule to automatically prevent said indication for a specified time, and to allow said communication after said specified time.

5. A system as in claim 1, wherein said processor operates according to said rule to determine that a number of communications occurred within a specified time and to automatically prevent said indication responsive to determining said number of communications having occurred within said specified time.

6. A system as in claim 1, wherein said processor specifies a time of communication which is automatically prevented.

7. A system as in claim 2, wherein said processor automatically actuates an electronic circuit within a communicator housing said memory to prevent the indication within the electronic circuit.

8. A system as in claim 1, wherein said memory also includes an indication which exempts users from being automatically blocked.

9. A system as in claim 1, further comprising a communicator part which communicates with a remote database.

10. A system as in claim 9, wherein said memory also stores information about a number of different contacts including said at least one identification, and stores said information on said remote database.

11. A system as in claim 10, wherein said database is used to look up specified parts of contact information for fields of said contacts, where said fields that are looked up are fields which do not include information therein.

12. A system as in claim 8, wherein said communicator part automatically forms information to be used for navigation to address information found within the contact information.

13. A system as in claim 1 wherein said system further comprises a manual actuation part that automatically allows selecting a specific identification whose indication is to be manually prevented.

13. A system as in claim 9, wherein said database automatically determines information from other contacts in said database from other people, and uses said information from said other contacts to fill in blank areas in the contact information.

14. A system as in claim 13, further comprising using information from contacts of other contacts.

15. A method comprising:
storing at least one identification indicative of a communication with a portable device;
receiving an incoming communication in said portable device;
obtaining an identification associated with a sender of said incoming communication;
determining if said identification has met a condition specified by a rule; and
automatically preventing further communication associated with said identification from creating an indication, responsive to said determining.

16. A method as in claim 15, wherein said identification is a telephone number, said indication is a ring associated with an incoming telephone call, and further comprising causing further communications from said telephone number to automatically be prevented from causing said ring.

17. A method as in claim 15, wherein said identification is an identification of a source of a written message, said indication is associated with signaling an incoming written message, and wherein said indication is said message being displayed, and said automatically preventing prevents said written message from being displayed.

18. A method as in claim 15, wherein said automatically preventing prevents said communication from creating said indication for a specified time, and allows said communication to create said indication after said specified time.

19. A method as in claim 15, wherein said automatically preventing comprises determining if a specified number of communications occurred within a specified time and to automatically prevent said indication responsive to determining said number of communications having occurred within said specified time.

20. A method as in claim 15, wherein said automatically preventing persists for a specified time of communication which is automatically prevented.

21. A method as in claim 15, wherein said automatically preventing actuates an electronic circuit within said portable device to prevent the indication within the portable device.

22. A method as in claim 15, further comprising allowing certain users to be exempted against being automatically blocked.

23. A method as in claim 22, further comprising communicating with a remote database.

24. A method as in claim 23, further comprising storing information about a number of different contacts including said at least one identification, and storing said information on said remote database.

25. A method as in claim 24, further comprising using said database to look up parts of contact information for fields of said contacts, where said fields that are looked up are fields which do not include information therein.

26. A method as in claim 23, further comprising automatically forming information to be used for navigation to address information found within the contact information and sending said information to a navigation system.

27. A method as in claim 15 further comprising manually adding a specific identification to be manually prevented.

28. A method as in claim 25, further comprising determining said parts using information from other contacts in said database from other people, and using said information from said other contacts to fill in said parts.

29. A method as in claim 28, further comprising using information from contacts of other contacts to fill in said information.

30. A method as in claim 28, further comprising using other contacts to fill in said information and determining a degree of relationship between said other contacts and a person whose contacts are being filled in.

31. A method, comprising:
receiving contact information into a computer that includes spaces for a number of different fields of contact information;
detecting at least some of said fields of said contact information which have been left blank;
Using a computer lookup function to determine information automatically, said information being associated with at least one of said fields of said contact information; and
filling in said field using said look up information.

32. A method as in claim 31, wherein said computer lookup function comprises a connection and query to at least one publicly available source of information.

33. A method as in claim 31, wherein said computer lookup function looks at other contact information associated with other users.

34. A method as in claim 33, further comprising determining a degree of relationship between said other contact information and said contact information.

35. A method as in claim 31, further comprising automatically detecting a communication, and automatically determining that said communication meets a specified criteria, and responsive to meeting said specified criteria, automatically preventing said communication from being indicated to the message recipient.

36. The method of claim 35, wherein said automatically preventing comprises preventing a phone from ringing to represent an incoming call from a contact, after detecting a communication of the contact that meets the specified criteria.

37. A method as in claim 35, wherein the automatically preventing comprises preventing a written message from being displayed from a contact, after detecting a communication of the contact that meets the specified criteria.
